(19) United States
(12) Patent Application Publication
(10) Pub. No.: US 2026/0116052 A1
(43) Pub. Date: Apr. 30, 2026

(54) VACUUM INSULATED GLASS PANELS FOR AN AUTOMOBILE

(71) Applicant: FCA US LLC, Auburn Hills, MI (US)

(72) Inventors: Gurumoorthy Venkatraman, Auburn Hills, MI (US); Rajaguru Durairaj, Auburn Hills, MI (US); Vijayamuthan Muthiah, Auburn Hills, MI (US)

(21) Appl. No.: 18/925,159

(22) Filed: Oct. 24, 2024

(51) Int. Cl. B32B 17/10

(52) U.S. Cl. CPC B32B 17/10036; B32B 17/10743; B32B 17/10761; B32B 2307/304; B32B 2307/7376; B32B 2605/00

(57) ABSTRACT

A vehicle comprising a vehicle body having a plurality of openings; and a plurality of glass panels respectively provided in each of the plurality of openings, wherein at least one of the glass panels includes a first laminate attached to a second laminate, and each of the first and second laminates are separated by an evacuated space; each of the first laminate and the second laminate including a glass layer, a resin layer, and an acrylic layer; and the acrylic layers face each other with the evacuated space therebetween.

### FIELD

The present disclosure relates to a vacuum insulated glass panel for an automobile.

### BACKGROUND

This section provides background information related to the present disclosure which is not necessarily prior art.

Automobiles may have a variety of glass panels that permit an occupant to see out of the vehicle and to permit ambient light to enter the vehicle. For example, an automobile may have a front windshield, a rear windshield, and door windows. In addition, the automobile may have a glass panel roof, or a movable glass panel roof (e.g., sunroof or moonroof). Inasmuch as these glass panels permit ambient light to enter the automobile, these glass panels also permit transfer of heat into the automobile. The transfer of heat into the cabin can cause a temperature of the cabin of the automobile to have a temperature that is greater than the ambient environment, which is generally undesirable.

A previous solution to mitigate the amount of heat that is transferred by the glass panels of the automobile included applying a tinted film to the glass panels. These tinted films, however, are only effective if the tint of the film is very dark, which may be prohibited in various states and other regions of the world. Another previous solution included having an air conditioning system of the automobile be remotely activated to cool the cabin before an occupant enters the automobile. This solution, however, does not mitigate the transfer of heat through the glass panels, and is also costly from a energy-usage standpoint.

### SUMMARY

This section provides a general summary of the disclosure, and is not a comprehensive disclosure of its full scope or all of its features.

According to a first aspect of the present disclosure there is provided a vehicle comprising a vehicle body having a plurality of openings; and a plurality of glass panels respectively provided in each of the plurality of openings, wherein at least one of the glass panels includes a first laminate attached to a second laminate, and each of the first and second laminates are separated by an evacuated space; each of the first laminate and the second laminate including a glass layer, a resin layer, and an acrylic layer; and the acrylic layers face each other with the evacuated space therebetween.

According to the first aspect, the resin layers are formed of polyvinyl butyral.

According to the first aspect, the acrylic layers are in the form of a cast sheet having a thickness that ranges between about 1.5 mm to about 2.5 mm.

According to the first aspect, a spacer is positioned between the first laminate and the second laminate.

According to the first aspect, the spacer includes an opening that permits the space between the acrylic layers to be evacuated before being closed by a plug to seal the space.

According to the first aspect, the evacuated layer restricts the transfer of heat from the first laminate to the second laminate.

According to a second aspect of the present disclosure, there is provided a glass panel, comprising a first laminate; a second laminate attached to the first laminate; and an evacuated space between the first laminate and the second laminate; wherein each of the first laminate and the second laminate include a glass layer, a resin layer, and an acrylic layer; and the acrylic layers face each other with the evacuated space therebetween.

According to the second aspect, the resin layers are formed of polyvinyl butyral.

According to the second aspect, the acrylic layers are in the form of a cast sheet having a thickness that ranges between about 1.5 mm to about 2.5 mm.

According to the second aspect, a spacer is positioned between the first laminate and the second laminate.

According to the second aspect, the spacer includes an opening that permits the space between the acrylic layers to be evacuated before being closed by a plug to seal the space.

According to the second aspect, the evacuated layer restricts the transfer of heat from the first laminate to the second laminate.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an isometric perspective view of a vehicle having a plurality of glass panels according to a principle of the present disclosure;

FIG. 2 is a schematic cross-sectional view of an example front windshield that may be used in the vehicle illustrated in FIG. 1.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

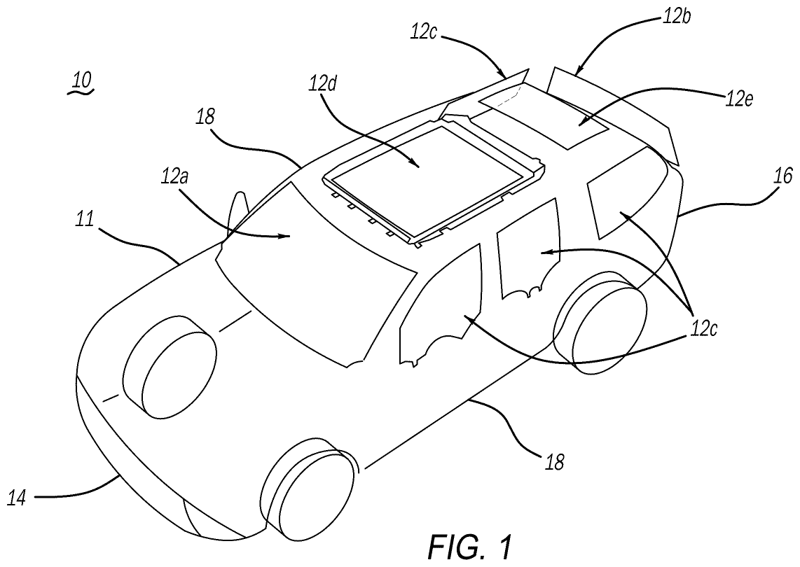

FIG. 1 illustrates a vehicle 10 having a body 11 that includes openings that include a plurality of glass panels 12a-12e according to a principle of the present disclosure. Glass panels of vehicle 10 may include a front windshield 12a located at a front 14 of the vehicle 10, a rear windshield 12b located at a rear 16 of the vehicle 10, a plurality of door windows 12c located on lateral opposing sides 18 of the vehicle 10, a fixed roof panel 12d, and a movable roof panel 12e such as a sunroof or a moonroof.

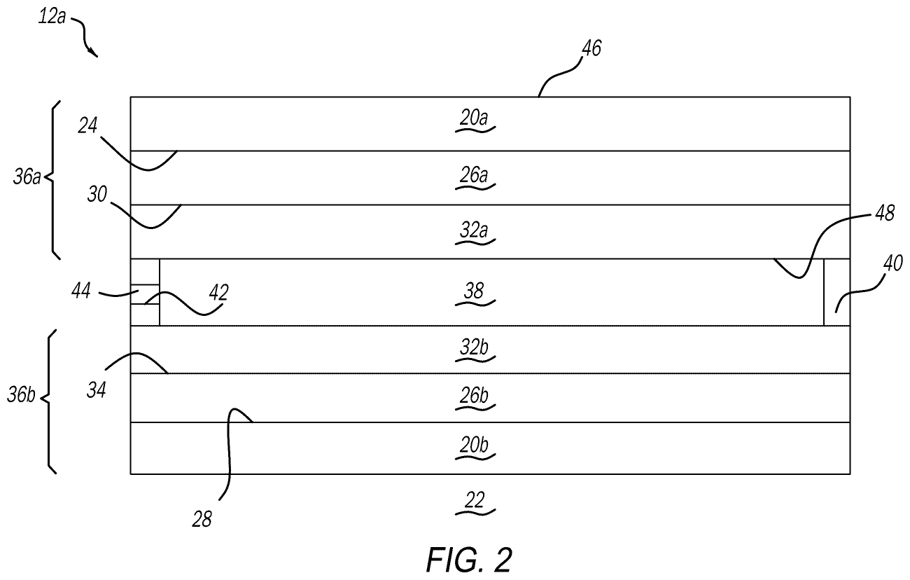

Now referring to FIG. 2, a cross-section of front windshield 12a is illustrated. It should be understood that front windshield 12a is shown in FIG. 2 for example purposes only, and that the other glass panels 12b-12e can have the same or a similar structure. As shown in FIG. 2, front windshield 12a has a plurality of layers including a first or outer glass layer 20a that faces away from an interior 22 of the vehicle 10 and a second or inner glass layer 20b that faces the interior 22 of the vehicle 10. First and second glass layers 20a and 20b may be formed of any type of glass known to one skilled in the art including, for example, annealed glass, tempered glass, low-E glass, and tinted glass. Preferably, the first and second glass layers 20a and 20b have a thickness that lies in the range of about 2.0 mm to about 2.5 mm, an impact strength in the range of about 2 kJ/m² to about 3 kJ/m², a tensile strength in the range of about 4.2 MPa to about 7 MPa, and a thermal conductivity in the range of about 0.8 W/m·K to about 1.0 /m·K.

Attached to a first interior surface 24 (i.e., a surface that faces interior 22) of the first glass layer 20a is a first resin layer 26a, and attached to a first outer surface 28 (i.e., a surface that faces away from interior 22) is a second resin layer 26b. First and second resin layers 26a, 26b may be formed of a material such as, for example, polyvinyl butyral (PVB). PVB strongly binds to interior surface 24 and outer surface 28 of first and second glass layers 20a, 20b, has good optical clarity, and exhibits toughness and flexibility. PVB, therefore, is a material that is often used in laminated safety glass panels such as an automotive windshield. In addition, it should be understood that PVB may be colored (i.e., tinted) if desired. A thickness of first and second resin layers 26a, 26b may lie in the range of about 0.25 mm to about 1.00 mm, and preferably about 0.75 mm.

Attached to a second interior surface 30 of first resin layer 26a is an first acrylic layer 32a, and attached to a second outer surface 34 of second resin layer 26b is a second acrylic layer 32b. The inclusion of first and second acrylic layers 32a, 32b improves the tensile strength of front windshield 12a because first and second acrylic layers 32a, 32b has a much greater tensile strength in comparison to first and second glass layers 20a, 20b, which permits front windshield 12a to resist tension much better in comparison to the use of glass alone, or a combination of two glass panels that sandwich a resin layer formed of, for example, PVB. In addition, the inclusion of first and second acrylic layers 32a, 32b offers significantly greater impact resistance to front windshield 12a because, in the case of an impact to front windshield 12a, the first and second acrylic layers 32a, 32b is more likely to absorb the force of the impact and resist shattering, which provides better overall durability and safety.

First and second acrylic layers 32a, 32b may each be cast as a sheet before being attached to first and second resin layers 26a, 26b. Because acrylic layers 32a, 32b are cast as a sheet rather than applied to resin layers 26a 26b as a thin film, a thickness of first and second acrylic layers 32a, 32b may lie in the range of about 1.50 mm to about 2.5 mm. By having first and second acrylic layers 32a, 32b have a thickness in the above range, the first and second acrylic layers 32a, 32b are much more durable and resistant to impacts to front windshield 12a in comparison to, for example, a polymer film being provided that has a thickness that is much less (e.g., about 0.01 mm to 0.20 mm). In addition, the thickness of first and second acrylic layers 32a, 32b provides front windshield 12a with more resistance to UV light, and offers excellent optical clarity in comparison to a thin polymer film that may be prone to optical distortion, particularly if not applied perfectly to the layer of material (e.g., glass) to which it is adhered.

The first and second acrylic layers 32a, 32b may have an impact strength of about 10 kJ/m² to about 20 kJ/m², which is significantly greater than glass. A tensile strength of the first and second acrylic layers 32a, 32b may lie in the range of about 50 MPa to about 70 MPa. A thermal conductivity of the first and second acrylic layers 32a, 32b may be about 0.19 W/m·K, which is also significantly less than that exhibited by the first and second glass layers 20a, 20b. Accordingly, the inclusion of first and second acrylic layers 32a, 32b can significantly assist in mitigating the amount of thermal transfer to the interior 22 of vehicle 10 by front windshield 12a.

The combination of first glass layer 20a, first resin layer 26a, and first acrylic layer 32a defines a first laminate 36a, and the combination of second glass layer 20b, second resin layer 26b, and second acrylic layer 32b defines a second laminate 36b. First and second laminates 36a, 36b are separated from each other by a vacuum space or layer 38, that is sealed using a polymeric (e.g., silicone) spacer 40. Unlike dual-paned glass panels, vacuum space or layer 38 does not include a gas. To ensure that space 38 is under vacuum, spacer 40 may include an opening 42 that permits the space 38 to be evacuated. After evacuating space 38, opening 42 may be sealed using a plug 44 that may be formed of a material similar to that used to form spacer 40 (e.g., silicone).

The inclusion of vacuum space or layer 38 offers advantages in both thermal and acoustic performance. In this regard, the vacuum space or layer 38 can function as a thermal insulation layer that inhibits the transfer of heat and sound from first laminate 36a to second laminate 36b. A thickness of vacuum space or layer 38 can be selected based on the application in which the glass panel is being used. For example, front windshield 12 is subjected to a much greater amount of air flow during operation of vehicle 10. Accordingly, in order to reduce road noise experienced in interior 22 of vehicle 10, a thickness of vacuum space or layer 38 may range between about 1.5 mm to about 2.5 mm. A similar thickness may be used for roof panels 12d and 12e. Glass panels 12b and 12c, however, may not be exposed to as great amounts of air flow and, therefore, not require the same thickness for vacuum space or layer 38. Glass panels 12b and 12c, therefore, may only require a thickness for vacuum space or layer 38 that lies in the range of about 0.5 mm to 1.5 mm. In addition to inhibiting transfer of thermal and acoustic energy from first laminate 36a to second laminate 36b, it should be appreciated that the use of vacuum space or layer 38 also inhibits the formation of fog on an exterior surface 46 of first glass layer 20a that faces away from the interior 22 of vehicle 10.

It should be understood that the configuration of FIG. 2 is merely a schematic representation of front windshield 12a and in practice, front windshield 12a and the other glass panels 12b-12e may have curved surfaces, as are common for aerodynamic purposes. In any event, to manufacture the glass panels 12a-12e, laminates 36a and 36b are first formed by applying a resin layer (e.g., 26a) to a surface (e.g., 24) of one of the glass layers (e.g., 20a). Resin layers 26a, 26b may be provided as a sheet that is adhered to the glass layers 20a, 20b, or may be applied by coating the resin of the resin layers 26a, 26b to an appropriate thickness and then permitting the resin to cure. After forming the resin layer (e.g., 26a), a cast sheet of acrylic is attached to the deposited resin layer (e.g., 26a) to form an acrylic layer (e.g., 32a). If resin layer has already cured, an adhesive (not shown) may be provided between acrylic layer (e.g., 32a) and the acrylic layer (e.g., 32a). Alternatively, if the resin has not cured, the resin will be tacky and permit the acrylic layer (e.g., 32a) to naturally adhere to the resin layer before curing.

After each laminate 36a and 36b has been formed, spacer 40 may be deposited about an outer periphery of one of the laminates (e.g., 36a). Specifically, the spacer 40 will be deposited to a surface 48 of one of the acrylic layers (e.g., 32a) around an outer periphery thereof and then the opposing laminate (e.g., 36b) will be adhered to the material (e.g., silicone) of the spacer 40. It is important that the acrylic layers 32a and 32b are positioned on opposite sides of the space 38 that will be evacuated. Thus, the opposing acrylic layer (e.g., 32b) will be adhered to the material of spacer 40. As noted above, spacer 40 may include an opening 42. Opening 42 may be provided by placing a hollow tube (not shown) upon the acrylic layer (e.g., 32a) before applying the material 40 of the spacer overtop thereof. Regardless, after the second laminate 36b has been adhered to the material of the spacer 40 attached to the acrylic layer 32a of the first laminate 36a and the material of the spacer 40 cured (e.g., by heating or by applying UV radiation), a needle (not shown) may be inserted through opening and space 38 evacuated. After evacuation, plug 44 may be inserted into opening 42.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a vehicle body having a plurality of openings; and
a plurality of glass panels respectively provided in each of the plurality of openings,
wherein at least one of the glass panels includes a first laminate attached to a second laminate, and each of the first and second laminates are separated by an evacuated space;
each of the first laminate and the second laminate including a glass layer, a resin layer, and an acrylic layer; and
the acrylic layers face each other with the evacuated space therebetween.

2. The vehicle according to claim 1, wherein the resin layers are formed of polyvinyl butyral.

3. The vehicle according to claim 1, wherein the acrylic layers are in the form of a cast sheet having a thickness that ranges between about 1.5 mm to about 2.5 mm.

4. The vehicle according to claim 1, wherein a spacer is positioned between the first laminate and the second laminate.

5. The vehicle according to claim 4, wherein the spacer includes an opening that permits the space between the acrylic layers to be evacuated before being closed by a plug to seal the space.

6. The vehicle according to claim 1, wherein the evacuated layer restricts the transfer of heat from the first laminate to the second laminate.

7. A glass panel, comprising:
a first laminate;
a second laminate attached to the first laminate; and
an evacuated space between the first laminate and the second laminate;
wherein each of the first laminate and the second laminate include a glass layer, a resin layer, and an acrylic layer; and
the acrylic layers face each other with the evacuated space therebetween.

8. The glass panel according to claim 7, wherein the resin layers are formed of polyvinyl butyral.

9. The glass panel according to claim 7, wherein the acrylic layers are in the form of a cast sheet having a thickness that ranges between about 1.5 mm to about 2.5 mm.

10. The glass panel according to claim 7, wherein a spacer is positioned between the first laminate and the second laminate.

11. The glass panel according to claim 10, wherein the spacer includes an opening that permits the space between the acrylic layers to be evacuated before being closed by a plug to seal the space.

12. The glass panel according to claim 7, wherein the evacuated layer restricts the transfer of heat from the first laminate to the second laminate.
